(19) United States
(12) Patent Application Publication
(10) Pub. No.: US 2025/0021378 A1
(43) Pub. Date: Jan. 16, 2025

(54) SYSTEMS, METHODS, AND APPARATUS FOR ASSIGNING OPERATIONS TO COMPUTATIONAL DEVICES

(71) Applicant: Samsung Electronics Co., Ltd., Suwon-si (KR)

(72) Inventors: Xueyang LIU, Atlanta, GA (US); Jing YANG, Glen Allen, VA (US); Rekha PITCHUMANI, Oak Hill, VA (US); Sahand SALAMAT, San Diego, CA (US); Joseph FINDLEY, San Jose, CA (US)

(21) Appl. No.: 18/765,214

(22) Filed: Jul. 5, 2024

Related U.S. Application Data
(60) Provisional application No. 63/526,675, filed on Jul. 13, 2023.

(51) Int. Cl. G06F 9/48; G06F 11/34

(52) U.S. Cl. CPC G06F 9/4881; G06F 11/3409

(57) ABSTRACT

A method may include determining, by at least one processing circuit, a first performance, on a first computational device, of a compute task, determining, by the at least one processing circuit, a second performance, on a second computational device, of the compute task, and assigning, by the at least one processing circuit, based on the first performance and the second performance, to the first computational device, the compute task. The determining the first performance may be based on a data transfer associated with the compute task. A method may include determining a characteristic of a compute task, determining a first configuration of a first computational device, determining a second configuration of a second computational device, and assigning, based on the characteristic of the compute task, the first configuration of the first computational device, and the second configuration of the second computational device, the compute task to the first computational device.

### REFERENCE TO RELATED APPLICATION

This application claims priority to, and the benefit of, U.S. Provisional Patent Application Ser. No. 63/526,675 filed Jul. 13, 2023 which is incorporated by reference.

### TECHNICAL FIELD

This disclosure relates generally to computational devices, and more specifically to systems, methods, and apparatus for assigning operations to computational devices.

### BACKGROUND

A computational device may include one or more compute resources that it may use to perform one or more compute tasks. A computational device may be used, for example, to offload a compute task from a host that may run an application implementing a computational workload.

The above information disclosed in this Background section is only for enhancement of understanding of the background of the inventive principles and therefore it may contain information that does not constitute prior art.

### SUMMARY

A method may include determining, by at least one processing circuit, a first performance, on a first computational device, of a compute task, determining, by the at least one processing circuit, a second performance, on a second computational device, of the compute task, and assigning, by the at least one processing circuit, based on the first performance and the second performance, to the first computational device, the compute task. The compute task may include at least one instruction, and the determining the first performance may be based on the at least one instruction. The determining the first performance may be based on a data transfer associated with the compute task. The compute task may be a first portion of a computational workload, and the assigning may be based on a dependency associated with the first portion of the computational workload on a second portion of the computational workload. The first computational device may include a compute resource, and the determining the first performance may be based on a type of the compute resource. The first computational device may include a configurable compute resource, and the method may further comprise configuring, based on the assigning, the configurable compute resource. The configuring may include loading, at the first computational device, a program for the configurable compute resource. The determining the first performance may be based on a characteristic of the compute task, and a configuration of the first computational device. The determining the first performance may be based on an operating status of the first computational device. The determining the first performance may be based on an operating status of the second computational device. The determining the first performance may be based on an operating status of a communication connection for the first computational device. The determining the first performance may be based on an operating status of a communication connection for the second computational device. The compute task may include at least one instruction, and the method may further include compiling, based on the assigning, the at least one instruction for the first computational device. The compute task may be a first portion of a computational workload, and the method may further include determining, based on the computational workload, the compute task.

A method may include determining a characteristic of a compute task, determining a first configuration of a first computational device, determining a second configuration of a second computational device, and assigning, based on the characteristic of the compute task, the first configuration of the first computational device, and the second configuration of the second computational device, the compute task to the first computational device. The assigning may be based on an operating status of the first computational device. The assigning may be based on a data transfer associated with the compute task.

A system may include a first computational device, a second computational device, and assignment logic configured to assign, based on a characteristic of a compute task, a first configuration of the first computational device, and a second configuration of the second computational device, the compute task to the first computational device. The assignment logic may be further configured to assign the compute task based on an operating status of the first computational device. The assignment logic may be further configured to assign the compute task based on a data transfer associated with the first computational device.

### BRIEF DESCRIPTION OF THE DRAWINGS

The figures are not necessarily drawn to scale and elements of similar structures or functions may generally be represented by like reference numerals or portions thereof for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1A illustrates an embodiment of a system for assigning compute tasks to one or more computational devices in accordance with example embodiments of the disclosure.

FIG. 1B illustrates an embodiment of a computational storage device having a configurable compute resource in accordance with example embodiments of the disclosure.

FIG. 2 illustrates an embodiment of a scheme for assigning compute tasks to one or more computational devices in accordance with example embodiments of the disclosure.

FIG. 3 illustrates another embodiment of a scheme for assigning compute tasks to one or more computational devices in accordance with example embodiments of the disclosure.

FIG. 4 illustrates an embodiment of a method for assigning compute tasks to one or more computational devices in accordance with example embodiments of the disclosure.

FIG. 5 illustrates an embodiment of a graph for determining dependencies for assigning compute tasks to one or more computational devices in accordance with example embodiments of the disclosure.

FIG. 6 illustrates an example embodiment of a software architecture in accordance with example embodiments of the disclosure.

FIG. 7 illustrates an embodiment of a computing system in accordance with example embodiments of the disclosure.

FIG. 8 illustrates an example embodiment of a computing system in accordance with example embodiments of the disclosure.

FIG. 9 illustrates another embodiment of a method for assigning compute tasks to one or more computational devices in accordance with example embodiments of the disclosure.

FIG. 10 illustrates a further embodiment of a method for assigning compute tasks to one or more computational devices in accordance with example embodiments of the disclosure.

### DETAILED DESCRIPTION

A computing system may include one or more computational devices to perform compute tasks for a computational workload. For example, a host may assign (e.g., offload) one or more compute tasks to one or more computational devices such as one or more central processing units (CPUs), graphics processing units (GPUs), computational storage devices (CSDs), and/or the like. Depending on the implementation details, a computational device may perform a compute task more effectively than a host in terms of throughput, bandwidth, energy consumption, and/or the like.

A compute task may be assigned to a computational device by a software developer and/or a compiler that may create an application to run a computational workload on a host. However, a decision by a developer and/or a compiler to assign a specific compute task to a specific computational device may be based on incomplete information about the capabilities of the specific computational device, the capabilities of one or more other computational devices that may perform the task more effectively, one or more data transfers that may be associated with the compute task, one or more runtime conditions that may determine the relative effectiveness of two different computational devices that may perform the task, and/or the like. Thus, depending on the implementation details, a developer and/or a compiler may assign a compute task to computational device that may be less effective overall than an alternative computational device.

A task assignment scheme in accordance with example embodiments of the disclosure may assign a compute task to a computational device based on one or more characteristics of the compute task, one or more dependencies of a compute task on another compute task, one or more configurations of one or more computational devices, one or more expected performance levels of running a compute task on one or more computational devices, one or more operating statuses of one or more computational devices and/or communication connections (e.g., data buses, interconnects, network connections, and/or the like) for a computational device (e.g., whether a computational device and/or communication connection is available or busy), and/or the like.

Additionally, or alternatively, a task assignment scheme in accordance with example embodiments of the disclosure may identify one or more compute tasks within a workload and assign the one or more identified compute tasks to one or more computational devices based on one or more characteristics, expected performance levels, operating conditions, and/or the like as disclosed herein. For example, some embodiments may identify one or more functions, instructions, and/or the like, within a portion of code for a workload that may indicate that the portion of code may be identified, handled, managed, and/or the like, as a one or more compute tasks (e.g., one or more distinct compute tasks).

Additionally, or alternatively, a task assignment scheme in accordance with example embodiments of the disclosure may determine one or more characteristics of a compute task that may be used to assign the compute task. For example, some embodiments may identify one or more functions, instructions, and/or the like, within a portion of code for a compute task that may indicate one or more characteristics of the compute task. Some embodiments may determine one or more dependencies between two or more compute tasks. For example, some embodiments may determine that an output of a first compute task may be used as an input to a second compute task which may affect scheduling of the first and second compute tasks or one or more transfers of operand and/or result data to and/or from one or more computational devices on which the first and second compute tasks may run.

Additionally, or alternatively, a task assignment scheme in accordance with example embodiments of the disclosure may receive configuration information for one or more computational devices. For example, some embodiments may receive information indicating a number and/or type of cores that a CPU, a GPU, and/or the like may have, a number and/or type of compute resources that a computational storage device may have, how many parallel compute tasks one or more compute resources at a computational storage device have be capable of performing, and/or the like.

Additionally, or alternatively, a task assignment scheme in accordance with example embodiments of the disclosure may determine one or more operating statuses of one or more computational devices, one or more communication connections for one or more computational devices, and/or the like, that may be used to assign a compute ask. For example, some embodiments may determine that a computational device is busy (e.g., operating at full throughput), idle (e.g., not performing an operation or available to perform an operation), or operating at a level between full throughput and idle. As another example, some embodiments may determine that a communication connection for a computational device may be busy (e.g., operating at full bandwidth), idle (e.g., not transferring data or available to transfer data), or operating at a level between full bandwidth and idle.

Additionally, or alternatively, a task assignment scheme in accordance with example embodiments of the disclosure may model (e.g., predict) one or more expected performances (e.g., compute time, data transfer time, and/or the like) of one or more compute tasks running on one or more computational devices. For example, some embodiments may determine a first performance of a compute task on a first computational device and a second performance of the compute task on a second computational device. The compute task may be assigned to one of the computational devices based on the first and second performances.

Additionally, or alternatively, a task assignment scheme in accordance with example embodiments of the disclosure may configure one or more compute resources associated with a computational device based on an assignment of a compute task to the computational device. For example, some embodiments may configure a programmable logic device at a computational storage device to perform a specific compute task assigned to the device.

This disclosure encompasses numerous aspects relating to the assignment of compute tasks to computational devices. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

For purposes of illustration, some embodiments may be described in the context of some specific implementation details such as specific types of compute tasks, computational devices, compute resources, communication connections, component configurations, and/or the like. However, the aspects of the disclosure are not limited to these or any other implementation details.

Multiple instances of elements identified with the same base numbers and different suffixes may be referred to individually and/or collectively by the base number. For example, one or more computational devices 102a, 102b, and/or 102c may be referred to individually and/or collectively as computational device or devices 102. As another example, one or more compute tasks 221-A, 221-B, 221-C, 221-D, and/or 221-E, . . . may be referred to individually and/or collectively as compute task or tasks 221.

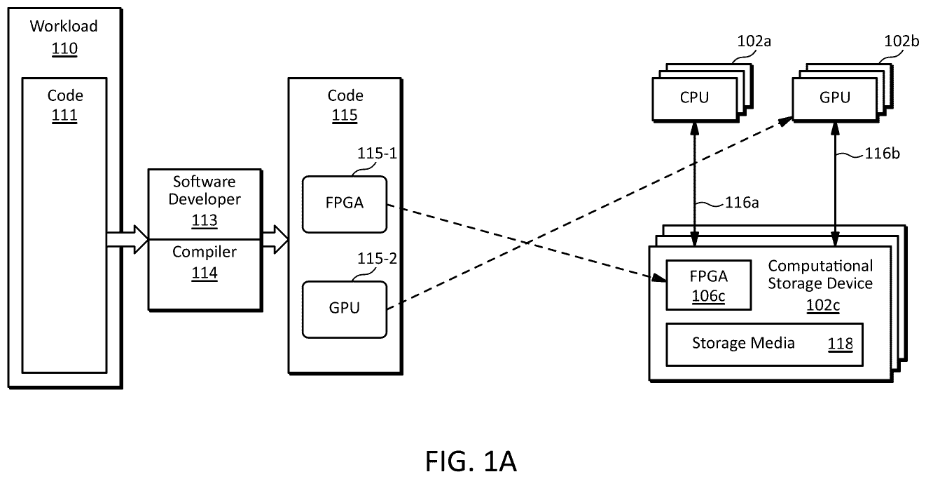

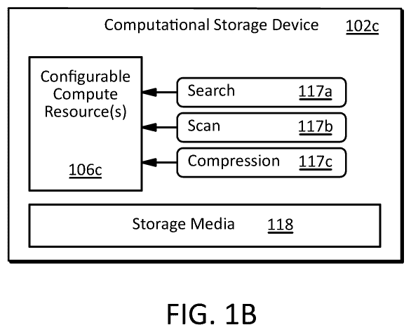

FIG. 1A illustrates an embodiment of a system for assigning compute tasks to one or more computational devices in accordance with example embodiments of the disclosure. In the embodiment illustrated in FIG. 1A, a computational workload 110 may include and/or be implemented with code 111 which may include program instructions for one or more operations (e.g., compute tasks) that may be performed by one or more computational devices such as one or more CPUs 102a, one or more GPUs 102b, one or more computational storage devices 102c, and/or the like, which may be referred to individually and/or collectively as computational devices 102.

A software developer 113 and/or a compiler 114 may process the code 111 to assign one or more portions of the code, which may implement one or more corresponding compute tasks, to one or more of the computational devices 102. For example, the software developer 113 and/or compiler 114 may process the code 111 to generate a version of the code 115 (which may be referred to as compiled code, annotated code, or revised code) in which a first portion of the code may implement a compute task 115-1 that may be executed using one or more configurable compute resources 106c at a computational storage device 102c. For purposes of illustration, the configurable compute resources 106c are illustrated as a field programmable gate array (FPGA), but the configurable compute resources 106c may be implemented with any other type of configurable compute resources such as one or more complex programmable logic devices (CPLDs), one or more processors that may be programmed to perform any type of computation, and/or the like.

A second portion of the code may implement a compute task 115-2 that may be executed using a GPU 102b. The software developer 113 and/or compiler 114 may assign the compute tasks 115-1 and 115-2 to the computational devices 102c and 102b, respectively, for example, during a code revision (e.g., optimization) operation.

In some embodiments, and depending on the implementation details, a software developer 113 may assign the compute tasks 115-1 and 115-2 based on limited experience with, and/or awareness of, the capabilities of one or more computational devices 102, limited experience with, and/or awareness of, one or more data transfers that may be associated with one or more of the compute tasks 115-1 and/or 115-2, limited experience with, and/or awareness of, one or more runtime conditions that may determine the relative effectiveness of two different computational devices that may perform the task, and/or the like. Similarly, the compiler 114 may not be capable of using one or more of these considerations to assign a compute task to one or more computational devices 102. Thus, depending on the implementation details, a developer 113 and/or a compiler 114 may assign a compute task to one computational device 102 that may be less effective overall than an alternative computational device 102.

For example, a developer 113 and/or a compiler 114 may assign a compute task 115-2 to a GPU 102b based on a parallel compute capability of the GPU 102b. For example, the compute task 115-2 may include a search and/or scan operation that may be performed in parallel and thus exploit the parallel compute capability of the GPU 102b. However, the developer 113 and/or compiler 114 may not know, and/or may not consider, that the compute task 115-2 may involve transferring a relatively large amount of operand data and/or result data between the GPU and a storage medium 118 at storage device 102c as shown by communication connection 116 in FIG. 1A.

Additionally, or alternatively, a developer 113 and/or a compiler 114 may not know, and/or may not consider, that the computational storage device 102c may include one or more specialized compute resources such as configurable compute resources 106c that may be capable of performing the compute task 115-2 (e.g., a scan or search operation). For example, as illustrated in FIG. 1B, a configurable compute resource 106c (e.g., an FPGA) at computational storage device 102c may be configured (e.g., programmed, hardwired, and/or the like), and/or reconfigured, to perform one or more of a search operation, a scan operation, and/or a compression operation, for example, by loading one or more computational programs (e.g., FPGA programs) 117a, 117b, and/or 117c, respectively, into the compute resource 106c. Moreover, depending on the implementation details, the configurable compute resource 106c may be capable of parallel operation, for example, in a manner similar to a GPU 102b.

Additionally, or alternatively, a developer 113 and/or a compiler 114 may not have access to information about runtime conditions that may indicate that a CPU 102a, GPU 102b, and/or communication connections 116a and/or 116B between a CPU 102a and/or GPU 102b and the computational storage device 102c may be busy when the compute task 115-2 is scheduled to run on the GPU 102b.

Thus, depending on the implementation details, operating conditions, and/or the like, a decision by a developer 113 and/or a compiler 114 to assign the compute task 115-2 to the GPU 102b instead of the computational storage device 102c may reduce the overall system performance of the compute task 115-2. For example, even if the GPU 102b, viewed in isolation, may be capable of performing the compute task 115-2 faster than the configurable compute resource 106c of the computational storage device 102c, the additional latency, power consumption, communication bandwidth, and/or the like, associated with transferring data for the compute task 115-2 between the GPU 102b and the computational storage device 102c may result in the GPU 102b being less effective at performing the compute task 115-2 than the computational storage device 102c. Moreover, depending on the implementation details, the configurable compute resource 106c may be capable of performing the compute task 115-2 as fast as, or faster than, the GPU 102b, especially, for example, if the compute resource 106c is capable of parallelizing the compute task 115-2 (e.g., a search operation 117a, a scan operation 117b, and/or a compression operation 117c as illustrated in FIG. 1B) which a developer 113 and/or a compiler 114 may not be aware of and/or consider when assigning the compute task 115-2.

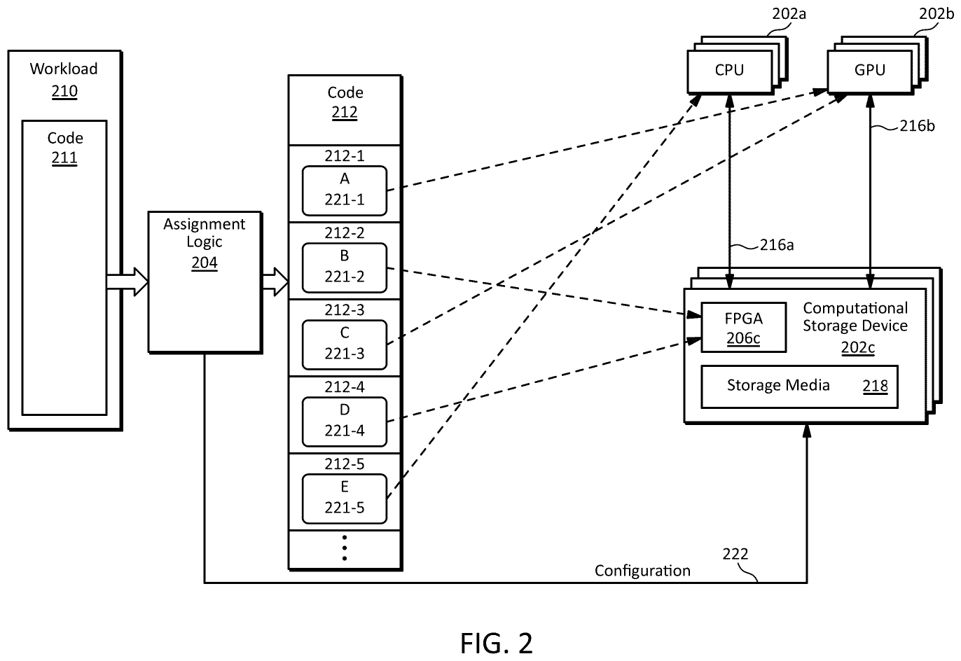

FIG. 2 illustrates an embodiment of a scheme for assigning compute tasks to one or more computational devices in accordance with example embodiments of the disclosure. In the embodiment illustrated in FIG. 2, elements similar to those illustrated in other figures may be indicated by reference numbers ending in, and/or containing, the same digits, letters, and/or the like.

Referring to FIG. 2, a computational workload 210 may include and/or be implemented with code 211 which may include program instructions for one or more operations (e.g., compute tasks) that may be performed by one or more computational devices such as one or more CPUs 202a, one or more GPUs 202b, one or more computational storage devices 202c, and/or the like, which may be referred to individually and/or collectively as computational devices 202.

The embodiment illustrated in FIG. 2 may also include assignment logic 204 that may perform one or more operations associated with assigning one or more portions of the computational workload 210 to one or more computational devices 202. The assignment logic 204 may be implemented, for example, with one or more applications, compilers, runtime environments, execution environments, operating systems, processes, services, virtual machines (VMs), VM managers, and/or the like, running at one or more hosts, servers, devices, clusters, datacenters, and/or the like.

For example, in some embodiments, the assignment logic 204 may identify one or more compute tasks within the workload 210. In some embodiments, the assignment logic 204 may process code 211 for computational workload 210 to generate a version of the code 212 (which may be referred to as compiled code, annotated code, or revised code), for example, by dividing code 211 into one or more portions of code 212-1, 212-2, 212-3, 212-4, 212-5, . . . based, for example, on one or more compute tasks 221-A (task A), 221-B (task B), 221-C (task C), 221-D (task D), 221-E (task E), . . . identified within the workload 210. In some embodiments, the assignment logic 204 may divide the computational workload 210 into one or more portions 212 based, for example, on relatively coarse-grained work regions (e.g., based on a block of code that may perform a specific function). The assignment logic 204 may identify a portion of code 212, compute task 221, work region, and/or the like, for example, by searching for one or more functions, instructions, data structures, calls, arguments, parameters, dependencies and/or the like, within a portion of code 212 that may indicate that the portion of code 212 may be identified, handled, managed, and/or the like, as one or more compute tasks (e.g., one or more distinct compute tasks), portions, work regions, and/or the like, that may be executed by a computational device.

For example, the assignment logic 204 may treat one or more (e.g., each) function as a compute task (e.g., a separate compute task). As another example, the assignment logic 204 may use artificial intelligence, (e.g., machine learning) to identify compute tasks. In an example embodiment using artificial intelligence, one or more machine learning models may be trained using a training data set that may include one or more performance metrics gathered from various types of applications such as GPU applications, FPGA applications, CPU applications, and/or the like. Performance metrics may be gathered, for example, using one or more code profiling tools that may generate performance profiles, memory profiles, event-based profiles, function-based profiles, and/or the like. The assignment logic 204 may use a trained model to divide a workload (e.g., automatically) into one or more compute tasks.

In some embodiments, a compute task 221 may refer to one or more operations that may be offloaded to a computational device 202, whereas a portion of code 212 of which the compute task 221 may be a part may also include one or more additional operations that may not be offloaded or may be better performed by a host (e.g., running on a CPU) on which the overall workload 210 (e.g., an application) may run. In some embodiments, a portion of code 212 may include more than one compute task 221, and/or a compute task 221 may be spread between different portions of code 212, and/or a compute task 221 may be coextensive with a portion of code 212.

As another example, in some embodiments, the assignment logic 204 may determine one or more characteristics of one or more (e.g., each) of the portions of code 212 and/or compute tasks 221 that affect the performance of the portions of code 212 and/or compute tasks 221, and thus, may be used to determine which computational device or devices 202 the portion of code 212 may be assigned to. Examples of characteristics may include one or more of a computational intensity, location of operand and/or result data (e.g., input and/or output data) for a compute task (which may also be referred to as data locality), amount of operand and/or result data for a compute task (which may also be referred to as a data transfer footprint), and/or the like. A computational intensity may be measured, quantified, and/or the like, based for example, on one or more operations that may be performed by a compute task. Examples of operations may include floating point operations (e.g., add, multiply, and/or the like), integer operations, and/or the like.

In some embodiments, the assignment logic 204 may determine one or more characteristics of one or more key operations of a portion of code 212 and/or compute task 221. The assignment logic 204 may determine a characteristic, for example, by searching for one or more functions, instructions, data structures, calls, arguments, parameters, dependencies and/or the like, within a portion of code 212 and/or compute task 221. Information about one or more characteristics of a portion of code 212 and/or compute task 221 may be referred to as a profile, and determining one or more characteristics may be referred to as profiling.

As a further example, in some embodiments, the assignment logic 204 may assign one or more of the portions of code 212 and/or compute tasks 221 to one or more of the computational devices 202 based, for example, on a fit (e.g., a best fit) between one or more characteristics (e.g., a profile) of a portion of code 212 and/or compute task 221 and one or more characteristics (e.g., a profile) of a one or more computational devices 202. In some embodiments, one or more profiles may be implemented with, and/or converted to, one or more vectors. In such an embodiment, a fit between a compute task 221 and a computational device 202 may be determined using a vector search based on a search technique such as approximate nearest neighbor (ANN).

For example, the assignment logic 204 may determine that tasks A and C have characteristics that are relatively computationally intensive (e.g., may include floating point operations). Thus, the assignment logic 204 may assign tasks A and C to one or more GPUs 202b. Additionally, or alternatively, the assignment logic 204 may determine that tasks B and D have characteristics that are relatively data transfer intensive (e.g., may include scanning, searching, and/or compressing relatively large amounts of data). Thus, the assignment logic 204 may assign tasks B and D to one or more compute resources 206c at one or more computational storage devices 202c. Additionally, or alternatively, the assignment logic 204 may determine that task E may have one or more characteristics that may be executed effectively using a CPU. Thus, the assignment logic 204 may assign task E to one or more CPUs 202a.

As a further example, the assignment logic 204 may configure and/or reconfigure one or more compute resources at one or more computational devices 202. For example, a compute resource 206c (e.g., an FPGA) at a computational storage device 202c may initially be configured to perform a scanning operation. An FPGA may be configured or reconfigured, for example, by loading configuration information (e.g., an FPGA program) into the FPGA. The assignment logic 204 may reconfigure the FPGA to perform a compression operation, for example, by sending configuration information 222 to the computational storage device 202c. The configuration information 222 may include, for example, one or more instructions to cause the computational storage device 202c to load an FPGA compression program into the FPGA. As another example, the configuration information 222 may include all or part of an FPGA compression program. The FPGA compression program may be stored at, and/or downloaded to, the computational storage device 202c. In some embodiments, the assignment logic 204 may configure and/or reconfigure one or more compute resources when code 212 is compiled (e.g., during ahead-of-time compiling, just-in-time (JIT) compiling, and/or the like), at runtime (which may also be referred to as online configuration), and/or the like.

As further examples, in some embodiments, the assignment logic 204 may determine one or more dependencies between one or more portions of code 212 and/or compute tasks 221, model (e.g., predict) expected performances (e.g., compute time, data transfer time, and/or the like) of one or more portions of code 212 and/or compute tasks 221 running on one or more computational devices 202, determine one or more operating statuses of one or more computational devices 202 and/or communication connections for one or more computational devices 202, assign one or more compute tasks 221 to one or more computational devices 202 based on one or more dependencies, expected performances, operating statuses, and/or the like, and/or other operations associated with assigning one or more portions of the computational workload 210 to one or more computational devices 202 as described in more detail below.

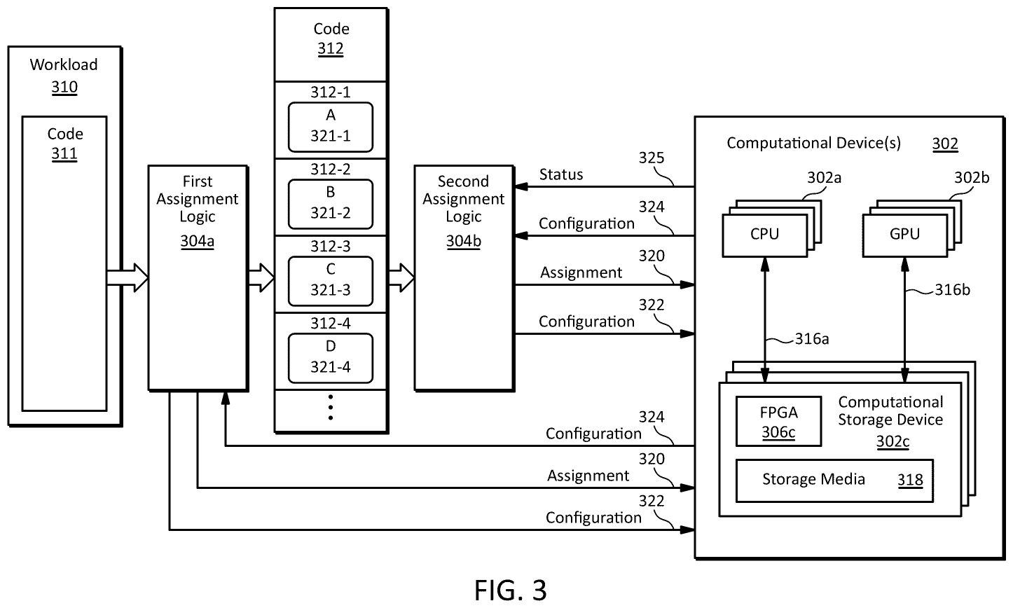

FIG. 3 illustrates another embodiment of a scheme for assigning compute tasks to one or more computational devices in accordance with example embodiments of the disclosure. In the embodiment illustrated in FIG. 3, elements similar to those illustrated in other figures may be indicated by reference numbers ending in, and/or containing, the same digits, letters, and/or the like. For example, the embodiment illustrated in FIG. 3 may include one or more computational devices 302 such as one or more CPUs 302a, one or more GPUs 302b, one or more computational storage devices 302c, and/or the like, which may be similar to those described with respect to FIG. 2.

In the embodiment illustrated in FIG. 3, assignment logic 304 may include a first portion 304a (which may also be referred to as assignment logic 304a or first assignment logic 304a) and a second portion 304b (which may also be referred to as assignment logic 304b or second assignment logic 304b). First assignment logic 304a (which may also be referred to, and/or characterized as, static assignment logic, offline assignment logic, compile time assignment logic, and/or ahead-of-time (AOT) assignment logic) may process code 311 for computational workload 310 to generate a version of code 312 (which may be referred to as static compiled code, static annotated code, or static revised code) in a manner similar to assignment logic 204 illustrated in FIG. 2. For example, first assignment logic 304a may generate code 312 by dividing code 311 into one or more portions of code 312-1, 312-2, 312-3, 312-4 . . . based, for example, on one or more compute tasks 321-A (task A), 321-B (task B), 321-C (task C), 321-D (task D), . . . identified within the workload 310.

First assignment logic 304a may determine one or more characteristics of one or more (e.g., each) of the portions of code 312 and/or compute tasks 321 in a manner similar to assignment logic 204 illustrated in FIG. 2. First assignment logic 304a may store one or more characteristics it may determine (e.g., one or more profiles for one or more computational devices 302) in a data structure such as a table, linked list, and/or the like.

In some embodiments, first assignment logic 304a may determine and/or receive configuration information 324 (which may also be referred to, and/or characterized as, configuration feedback information) associated with one or more computational devices 302 and/or one or more communication connections 316. Examples of configuration information 324 may include numbers and/or types of cores a CPU 302a, GPU 302b, and/or the like may have. Further examples of configuration information 324 may include information about compute resources 306c in a computational storage device 302c such as number and/or type of FPGAs, ASICs, and/or the like, number and/or type of programs (e.g., FPGA programs, computational storage programs, functions, and/or the like) that may be loaded, executed, and/or the like by the compute resources 306c, and/or stored at the computational storage device 302c, number and/or type of parallel compute tasks the compute resources 306c may be capable of loading, executing, and/or the like. Another example of configuration information 324 may include an amount and/or type of memory available at a computational device 302. Another example of configuration information 324 may include information about a topology of one or more communication connections such as locations and/or configurations of one or more root complexes, switches, and/or links between computational devices 302, and/or the like. In some embodiments, configuration information 324 may be provided, for example, by one or more device drivers for computational devices 302, one or more configuration files, and/or the like. First assignment logic 304a may store configuration information 324 in a data structure such as a table, linked list, and/or the like.

In some embodiments, first assignment logic 304a may determine one or more dependencies between one or more portions of code 312 and/or compute tasks 321 that may affect assignment and/or scheduling of the one or more portions of code 312 and/or compute tasks 321. For example, first assignment logic 304a may determine that an output of a first compute task 321-A may be used as an input to a second compute task 321-C and, thus, at least a portion of the second compute task 321-C may be scheduled to begin after at least a portion of the first compute task 321-A may be completed. Additionally, or alternatively, first assignment logic 304a may determine one or more dependencies that may affect data transfers to and/or from one or more computational devices 302. For example, a determination that an output of a first compute task 321-A may be used as an input to a second compute task 321-C may be used to schedule a data transfer from a first computational device 302 on which the first compute task 321-A may run to a second computational device 302 on which the second compute task 321-C may run. First assignment logic 304a may store one or more dependencies in a data structure such as a table, linked list, and/or the like.

Additionally, or alternatively, first assignment logic 304a may determine (e.g., predict) one or more expected performances of one or more portions of code 312 and/or compute tasks 321 running on one or more computational devices 302, for example, by modeling the operation of one or more portions of code 312 and/or compute tasks 321 on one or more computational devices 302. In some embodiments, a modeling operation may be based on one or more characteristics (e.g., a profile) of a portion of code 312 and/or compute task 321 and/or one or more configurations of one or more computational devices 302 and/or communication connections 316.

For example, first assignment logic 304a may determine a first performance of compute task 321-A running on a GPU 302b based on one or more characteristics of compute task 321-A, configuration information for the GPU 302b, and/or configuration information for a communication connection 316b. In some embodiments, the first performance may include a portion (e.g., an amount of time) for the GPU 302b to perform compute task 321-A and a second portion (e.g., an amount of time that may be referred to as a transfer time penalty) to transfer input data for compute task 321-A from a computational storage device 302c to the GPU 302b using communication connection 316b.

First assignment logic 304a may also determine a second performance of compute task 321-A running on a computational storage device 302c based on the one or more characteristics of compute task 321-A and/or configuration information for one or more compute resources 306c at the computational storage device 302c. In this example, input data for compute task 321-A may already be located at the computational storage device 302c. First assignment logic 304a may assign compute task 321-A to the GPU 302b or the computational storage device 302c based on the first and second performances. For example, the GPU 302b may perform compute task 321-A faster than the computational storage device 302c (e.g., the first portion of the first performance may be shorter than the second performance), but the transfer time associated with transferring the input data to the GPU 302b (e.g., the second portion of the first performance) may cause the overall first performance (e.g., the sum of the first and second portions) to be longer than the second performance determined for the computational storage device 302c. Thus, first assignment logic 304a may assign compute task 321-A to the computational storage device 302c. Depending on an existing configuration of the one or more compute resources 306c at the computational storage device 302c, first assignment logic 304a may reconfigure the one or more compute resources 306c to perform compute task 321-A. For example, first assignment logic 304a may instruct an FPGA at the computational storage device 302c to load an FPGA program (which may be stored at, and/or sent to, the computational storage device 302c) to perform compute task 321-A.

In some embodiments, first assignment logic 304a may determine one or more performances of one or more compute tasks 321 (e.g., each compute task) on one or more computational devices 302 (e.g., each device that may be capable of executing the compute task), and assign one or more compute tasks 321 (e.g., each compute task) to a computational device 302 that may provide an acceptable or best overall system performance (e.g., in terms of overall execution time, power consumption, and/or the like). In some embodiments, a performance modeling operation may determine a performance based on a computational device (e.g., a single device performance) that may include modeling one or more operations (e.g., one or more key operations that may be captured as compute task characteristics) of one or more compute tasks to estimate a compute time. Additionally, or alternatively, in some embodiments, a performance modeling operation may determine a performance based on a data transfer overhead, for example, based on a location of data for a compute task (e.g., locality of data stored in cache, memory, storage, and/or the like) to estimate time for one or more data access operations such as read and/or write, load and/or store, and/or the like.

Additionally, or alternatively, first assignment logic 304a may compile code to execute one or more portions of code 312 and/or compute tasks 321 using one or more computational devices 302. For example, if first assignment logic 304a assigns compute task 321-A to a CPU 302a, assignment logic 304a may compile code for compute task 321-A to run on the CPU 302a. Similarly, if assignment logic 304a assigns compute task 321-A to a computational storage device 302c, assignment logic 304a may compile code for compute task 321-A to run on an FPGA or other compute resource 306c at the computational storage device 302c.

Additionally, or alternatively, first assignment logic 304a may configure and/or reconfigure one or more compute resources at one or more computational devices 302, for example, to perform one or more compute tasks 321 that assignment logic 304a may have assigned to the computational device(s) 302. Assignment logic 304a may configure and/or reconfigure one or more compute resources, for example, by sending configuration information 322 to the computational device 302. The configuration information 322 may include, for example, one or more instructions to cause a computational a device 302 to load an FPGA program into an FPGA at the computational device 302. As another example, the configuration information 322 may include all or part of an FPGA or other computational device program.

In some embodiments, first assignment logic 304a may generate code 312 (e.g., annotated code), identify one or more compute tasks 321, determine one or more characteristics of one or more portions of code 312 and/or compute tasks 321, receive configuration information 324, determine one or more dependencies, determine one or more expected performance, assign one or more compute tasks 321, and/or the like, at least partially prior to running the code 312 (e.g., by statically compiling at least a portion of the code 312). For example, first assignment logic 304a may be implemented at least partially with a compiler and/or interpreter implemented with Low Level Virtual Machine (LLVM), e.g., with a plug-in, extension, and/or the like, for LLVM, GNU Compiler Collection (GCC), Clang, and/or the like. In some embodiments, first assignment logic 304a may use one or more optimizing features of a compiler and/or interpreter to determine (e.g., model, predict, and/or the like) a performance of a compute task 321 on a computational device 302.

In some embodiments, first assignment logic 304a may implement an assignment of a compute task 321 to a computational device 302, for example, by sending a first type of assignment information 320 such as code (e.g., compiled code) for the compute task to the computational device 302, by sending a second type of assignment information 320 such as one or more instructions, indications, and/or the like to the computational device 302, by notifying an execution environment of the assignment, by notifying a scheduler of the assignment, by placing a compute task in a queue (e.g., for a computational device 302), by inserting one or more annotations (e.g., one or more comments) indicating the assignment in code 312 (e.g., annotated code) such that a compiler, interpreter, and/or the like may cause the compute task 321 to be executed using the computational device 302, and/or in any other suitable manner.

Second assignment logic 304b (which may also be referred to, and/or characterized as, dynamic assignment logic, online assignment logic, runtime assignment logic, and/or just-in-time (JIT) assignment logic) may use status information 325 (which may also be referred to as feedback information) to assign one or more compute tasks 321 to one or more computational devices 302. Status information 325 may include information on one or more operating statuses of one or more computational devices 302, one or more communication connections 316, and/or the like.

Examples of operating status information for a computational device 302 may include a binary status of an activity level of the device or one or more cores thereof (e.g., whether the device is busy or available or how many cores are busy or available), a continuous or multi-valued status of an activity level of the device or one or more cores thereof (e.g., full throughput, idle, or a value between full throughput and idle), a number of tasks in a queue for the device, whether the device is operating in a thermal throttling mode, whether a specific compute task is pending (e.g., in a queue, currently being executed, and/or the like) or completed, and/or the like.

Examples of operating status information for a communication connection 316 may include a binary status of an activity level of the connection or one or more lanes thereof (e.g., whether the connection is busy or available or how many lanes are busy or available), a continuous or multi-valued status of an activity level of the connection or one or more lanes thereof (e.g., full bandwidth, idle, or a value between full bandwidth and idle), a number of transfers in a queue for the connection, whether the connection is operating in a fail-over mode, and/or the like.

In some embodiments, second assignment logic 304b may implement one or more (e.g., all) of the functions and/or capabilities of first assignment logic 304a but with one or more additional functions and/or capabilities based on access to status information 325. For example, in some embodiments, second assignment logic 304b may generate code 312 (e.g., annotated code), identify one or more compute tasks 321, determine one or more characteristics of one or more portions of code 312 and/or compute tasks 321, receive configuration information 324. determine one or more dependencies, and/or the like, in a manner similar to first assignment logic 304a.

However, second assignment logic 304b may use status information 325 (e.g., operating condition information which may also be referred to, and/or characterized, as execution information, runtime information, and/or real-time information) to determine (e.g., predict) one or more expected performances of, assign, schedule, and/or the like, one or more portions of code 312 and/or compute tasks 321 on one or more computational devices 302. Depending on the implementation details, this may enable second assignment logic 304b to improve (e.g., optimize) one or more performance aspects of one or more portions of code 312 and/or compute tasks 321, one or more computational devices 302, an overall performance of the computing system illustrated in FIG. 3, and/or the like. Moreover, second assignment logic 304b may perform one or more (e.g., any) of the operations performed by first assignment logic 304a, however, with the benefit of status information 325 that may be available at or near execution operation (e.g., runtime) for one or more compute tasks 321.

For example, second assignment logic 304b may use status information 325 to determine a first performance (e.g., predicting an expected performance by modeling) of compute task 321-A running on a GPU 302b and a second performance of compute task 321-A running on a computational storage device 302c in a manner similar to first assignment logic 304a as described above. However, second assignment logic 304b may have access to status information 325 that may indicate that an FPGA or other compute resource 306c at the computational storage device 302c may be busy with another computation and/or may have a task queue that is relatively full, and thus, running compute task 321-A on the computational storage device 302c may involve a wait time. Thus, second assignment logic 304b may determine that the second performance associated with running compute task 321-A on the computational storage device 302c may involve a longer time duration than a first performance of compute task 321-A running on the GPU 302b, even though the first performance may include a data transfer. Thus, second assignment logic 304b may assign compute task 321-A to the GPU 302b. Moreover, in some embodiments, and depending on the implementation details, second assignment logic 304b may compile code for compute task 321-A to run on the GPU 302b (or recompile code if first assignment logic 304a previously compiled code for compute task 321-A to run on the computational storage device 302c). Second assignment logic 304b may compile code, for example, using a JIT compiler.

As another example, second assignment logic 304b may determine a first performance of compute task 321-C running on a CPU 302a and a second performance of compute task 321-A running on a GPU 302b. Based on a relative number of cores, compute task 321-A may be expected to execute faster on the GPU 302b than the CPU 302a. However, second assignment logic 304b may use status information 325 to determine that half of the cores in the GPU 302b are busy, and thus, based on current operating status, the first performance of compute task 321-C running on the CPU 302a may be better than the second performance of compute task 321-A running on the GPU 302b. Thus, second assignment logic 304b may assign and/or schedule compute task 321-C to run on the CPU 302a, and/or the like.

In some embodiments, second assignment logic 304b may generate code 312 (e.g., annotated code), identify one or more compute tasks 321, determine one or more characteristics of one or more portions of code 312 and/or compute tasks 321, receive configuration information 324, receive status information 325, determine one or more dependencies, determine one or more expected performance, assign and/or schedule one or more compute tasks 321, compile and/or recompile code (e.g., using JIT compilation) for one or more compute tasks 321, and/or the like, at least partially at a runtime for workload 310. For example, second assignment logic 304b may be implemented at least partially with a compiler, interpreter, and/or execution environment (e.g., a runtime environment) implemented with LLVM (e.g., with a plug-in, extension, and/or the like, such as GraalVM LLVM Runtime for LLVM), GCC, Clang, and/or the like. In some embodiments, second assignment logic 304b may use one or more optimizing features of a compiler to determine (e.g., model, predict, and/or the like) a performance of a compute task 321 on a computational device 302.

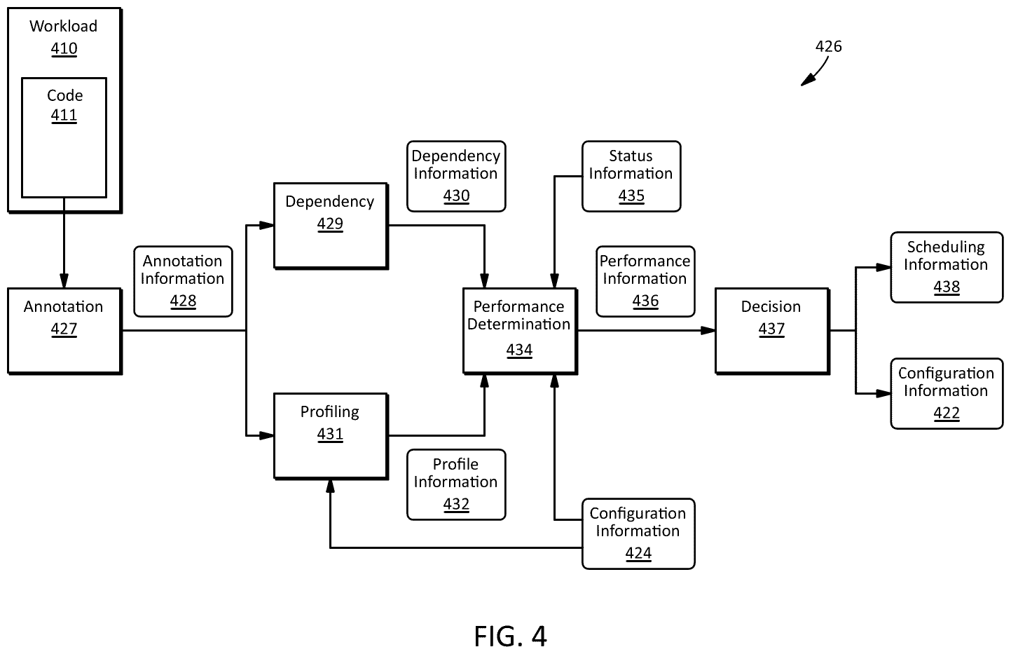

FIG. 4 illustrates an embodiment of a method for assigning compute tasks to one or more computational devices in accordance with example embodiments of the disclosure. The method 426 illustrated in FIG. 4 may be used, for example, to implement any of the assignment schemes disclosed herein including those described with respect to other figures in which similar elements may be indicated by reference numbers ending in, and/or containing, the same digits, letters, and/or the like. In some embodiments, the method 426 may be implemented with, and/or be used to implement, any of the assignment logic described herein including assignment logic 204 illustrated in FIG. 2 and/or assignment logic 304 illustrated in FIG. 3. In some embodiments, and depending on the implementation details, some or all of the method 426 may be referred to, and/or characterized as, a toolchain (e.g., a modeling toolchain).

Referring to FIG. 4, the assignment method 426 may include an annotation operation 427 that may receive a workload 410 as an input. The workload 410 may include and/or be implemented with code 411 which may include program instructions for one or more operations (e.g., compute tasks) that may be performed by one or more computational devices. The annotation operation 427 may annotate code 411, for example, by dividing the code 411 into one or more compute tasks based, for example, on identifying one or more functions, instructions, data structures, calls, arguments, parameters, dependencies and/or the like, within a portion of code 411 that may indicate that the portion of code may be identified, handled, managed, and/or the like, as one or more compute tasks (e.g., one or more distinct compute tasks).

In some embodiments, the annotation operation 427 may divide the code 411 into one or more relatively coarse grained compute tasks (e.g., blocks of code) based, for example, on one or more functions performed by the compute task or tasks. In other embodiments, however, the annotation operation 427 may divide the code 411 into one or more relatively fine grained compute tasks, for example, on a line-by-line basis. In some embodiments, the annotation operation 427 may generate annotation information 428 in the form of a version of code 411 having annotations (e.g., comments) indicating one or more compute tasks (e.g., beginning and/or ending lines of code, functions, subroutines, calls, and/or the like). Additionally, or alternatively, in some embodiments, the annotation operation 427 may generate annotation information 428 in the form of entries in one or more data structures (e.g., one or more tables) indicating beginning and/or ending lines of code, functions, subroutines, calls, and/or the like. In some embodiments, the annotation operation 427 may be implemented, for example, with one or more passes of a compiler, interpreter, plug-in or extension for a compiler and/or an interpreter, and/or the like (e.g., which may scan the code 411 to find indications of one or more compute tasks).

The assignment method 426 may include a dependency operation 429 that may generate dependency information 430 that may indicate one or more dependencies between compute tasks identified by the annotation operation 427. In some embodiments, a dependency may indicate that a data transfer may be useful or necessary between two compute tasks, devices, and/or the like (e.g., between one or more computational devices, storage devices, data input and/or output devices, memory devices, and/or the like). For example, if first and second compute tasks execute on two different computational devices and output data the first compute task may be used as input data to the second compute task, this may indicate a dependency between the two compute tasks. Thus, the compute tasks may be scheduled, and/or the data may be transferred between the computational devices executing the compute tasks, to accommodate the dependency (e.g., in the case of batch data, to enable the output data from the first compute task to be transferred to the second compute task before the second compute task begins, or in the case of streaming data, to enable a data stream to be established between the first and second compute tasks). As another example, if a compute task uses input data that is stored at a storage device, this may indicate a dependency between the compute task and a data transfer operation (which, depending on the implementation details, may also be referred to as a compute task).

In some embodiments, the dependency operation 429 may generate dependency information 430 in the form of a version of code 411 having annotations (e.g., comments) indicating one or more dependencies, in the form of entries in one or more data structures (e.g., one or more tables), in the form of a graph (e.g., a directed acyclic graph (DAG)), and/or the like. In some embodiments, the dependency operation 429 may be implemented, for example, with one or more passes of a compiler, interpreter, plug-in or extension for a compiler and/or an interpreter, and/or the like (e.g., which may scan the code 411 and/or read information from a data structure to find indications of one or more dependencies).

The assignment method 426 may include a profiling operation 431 that may determine one or more characteristics of one or more compute operations (e.g., each compute operation) identified by the annotation operation 427. For example, the profiling operation 431 may determine one or more of a computational intensity, location of operand and/or result data (e.g., input and/or output data) for a compute task, amount of operand and/or result data for a compute task, and/or the like. The profiling operation 431 may determine a characteristic, for example, by searching for one or more functions, instructions, data structures, calls, arguments, parameters, dependencies, and/or the like, within a compute task. In some embodiments, the profiling operation 431 may receive and/or use configuration information 424 (which may also be referred to, and/or characterized as, configuration feedback information) about one or more computational devices on which the compute task may run to determine one or more characteristics of a compute task. For example, in some embodiments, the profiling operation 431 may use configuration information 424 to determine one or more characteristics that may affect the performance of a compute task that may run on a specific computational device.

The profiling operation 431 may generate profile (e.g., characteristic) information 432 in the form of a version of code 411 having annotations (e.g., comments) indicating characteristics of one or more compute tasks. Additionally, or alternatively, in some embodiments, the profiling operation 431 may generate profile (e.g., characteristic) information 432 in the form of entries in one or more data structures (e.g., one or more tables). In some embodiments, the profiling operation 431 may be implemented, for example, with one or more passes of a compiler, interpreter, plug-in or extension for a compiler and/or an interpreter, and/or the like (e.g., which may scan the code 411, read information from a data structure, receive configuration information 424, and/or the like, to find indications of one or more characteristics).

The assignment method 426 may include a performance determination operation 434 that may determine (e.g., predict by modeling) one or more expected performances (e.g., compute time, data transfer time, and/or the like) of one or more compute tasks running on one or more computational devices. For example, in some embodiments, the determination operation 434 may predict the performances of running one or more (e.g., each) compute task on one or more different computational devices (which may also be referred to as platforms). In some embodiments, data transfer may be modeled based on one or more data dependencies between compute tasks that may be captured (e.g., determined) by the dependency operation 429.

The performance determination operation 434 may determine one or more performances based, for example, on dependency information 430, profile (e.g., characteristic) information 432, device configuration information 424, and/or status information 435. For example, the performance determination operation 434 may model the performance of a compute task on a computational device to determine an expected execution time (which may include data transfer time) based on profile (e.g., characteristic) information 432 of the compute task (e.g., a floating point operation, a scan operation, a search operation, a compression operation, and/or the like), dependency information 430 for the compute task (e.g., one or more locations of operand and/or result data for the compute operation and resulting data transfer overhead), device configuration information 424 for one or more computational devices on which the compute task may be executed (e.g., a number and/or type of cores in a CPU and/or GPU, a configuration of compute resources (including parallel operation capabilities) such as an FPGA in a computational storage device), and/or status information 435 for one or more computational devices on which the compute task may be executed (e.g., whether a computational device and/or one or more cores thereof is/are available or busy, operating in a thermal throttling mode, and/or the like; whether one or more communication connections for a computational device is available or busy, operating in a fail-over mode, and/or the like).

The performance determination operation 434 is not limited to any specific implementation details. However, for purposes of illustration, some example embodiments may operate based on one or more simplifying assumptions. For example, some embodiments may assume data transfer to a computational device for a compute task may be sequential with executing the compute task (e.g., the compute task may perform a batch operation as opposed to streaming operation). As another example, some embodiments may assume the bandwidth (e.g., data throughput) of one or more communication connections may be relatively constant. As another example, some embodiments may assume one or more compute resources (e.g., an FPGA in a computational storage device) may follow a roofline performance model. In such embodiments, the performance determination operation 434 may combine profile information for one or more compute operations with one or more of the assumptions described above to determine (e.g., predict by modeling) the performances of one or more compute tasks running on one or more computational devices. In other embodiments, however, performance determination operation 434 may model one or more compute tasks based on one or more data transfer operations that may be concurrent with one or more compute tasks that may use the data (e.g., a streaming operation), based on different bandwidth for data transfer operations using different communication connections, and/or based on any type of performance models for one or more compute resources.

The performance determination operation 434 may generate performance information 436 in the form of a version of code 411 having annotations (e.g., comments) indicating one or more expected performances of one or more compute tasks on one or more computational devices (including, for example, execution time, data transfer overhead, and/or the like). Additionally, or alternatively, in some embodiments, the performance determination operation 434 may generate performance information 436 in the form of entries in one or more data structures (e.g., one or more tables). In some embodiments, the performance determination operation 434 may be implemented, for example, with one or more passes of a compiler, interpreter, plug-in or extension for a compiler and/or an interpreter, and/or the like (e.g., which may scan the code 411, read information from a data structure, receive configuration information 424, status information 435, and/or the like, to find information on which to base one or more performance determinations).

The assignment method 426 may include a decision operation 437 that may, based at least in part on the performance information 436, determine which computational device to assign one or more (e.g., each) compute task to, schedule one or more (e.g., each) compute task, configure one or more compute resources at a computational device, compile (or recompile) code for one or more compute tasks to execute on one or more assigned computational devices, and/or the like.

In some embodiments, the decision operation 437 may assign and/or schedule one or more compute tasks (e.g., each compute task) to one or more computational devices that may provide the best or acceptable performance for individual compute tasks. In some other embodiments, the decision operation 437 may assign and/or schedule one or more compute tasks (e.g., each compute task) to one or more computational devices that may provide the best or acceptable overall performance from a system perspective. For example, even though a first compute task may perform faster or more efficiently on a first computational device, assigning the first compute task to a second computation device may improve the overall system performance if it frees up the first computational device to perform one or more other compute tasks that may be more computationally and/or power intensive. Moreover, if the first compute task involves transferring operand and/or result data to the first computation device, the data transfer may result in an idle time at the first computation device which may further reduce overall system performance. Such an idle time may be especially detrimental if the first computation device operates in a pipeline mode, in which case, the idle time waiting for data for the first compute task may stall one or more other compute tasks in the pipeline.

In some embodiments, the decision operation 437 may schedule one or more compute tasks based on (e.g., to avoid) data transfer time overhead that may be incurred by scheduling dependent compute tasks on different computational devices. For example, a first compute task may provide a relatively high performance on a first computational device, and a second compute task that may use an output of the first compute task as an input may provide a relatively high performance on a second computational device. However, transferring the output data of the first compute task from the first computational device to the second computational device may incur a transfer time overhead. Thus, if the first computational device may perform the second compute task, albeit at a relatively lower performance level, the benefit from avoiding the data transfer may outweigh the performance reduction associated with executing the second compute task with the first computational device. Thus, the decision operation 437 may schedule both compute tasks on the first computational device. Moreover, if the first computational device may be reconfigured to perform the second compute task faster, more efficiently, and/or the like, the decision operation 437 may reconfigure the first computational device accordingly which. depending on the implementation details, may further improve overall system performance. Thus, in some embodiments, the decision operation 437 may use dependency information to improve scheduling order and/or take a transfer time penalty into consideration.

In some embodiments, the decision operation 437 may provide an estimate (e.g., to a user, administrator, host, and/or the like) of an estimated performance improvement associated with assigning one or more compute tasks based on overall system performance.

In some embodiments, the decision operation 437 may provide output in the form of compute task scheduling information 438 for one or more compute tasks on one or more computational devices. The scheduling information 438 may be used, for example, by an execution environment (e.g., a runtime environment), a virtual machine, an operating system scheduler, and/or the like. Additionally, or alternatively, the decision operation 437 may provide output in the form of device configuration information 422 for one or more computational devices. The device configuration information 422 may include, for example, one or more instructions that may cause one or more configurable compute resources at a computational device to load, execute, and/or the like, one or more programs (e.g., FPGA programs, computational device programs or functions, and/or the like). The device configuration information 422 may be sent to a computational device, for example, using a device driver for the computational device.

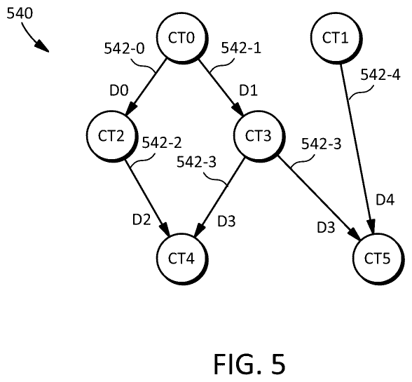

FIG. 5 illustrates an embodiment of a graph for determining dependencies for assigning compute tasks to one or more computational devices in accordance with example embodiments of the disclosure. The graph 540 illustrated in FIG. 5 may be used, for example, to implement any of the assignment schemes disclosed herein including those described with respect to other figures in which similar elements may be indicated by reference numbers ending in, and/or containing, the same digits, letters, and/or the like. In some embodiments, the graph 540 may be implemented with, and/or be used to implement, the dependency operation 429 illustrated in FIG. 4. For example, the graph 540 may be generated by the dependency operation 429 and/or used to provide dependency information to a performance determination operation 434, a decision operation 437, and/or the like.

Referring to FIG. 5, the graph 540 may be implemented with a directed acyclic graph in which one or more nodes indicated by circles may represent one or more compute tasks CT0, CT1, . . . , and edges 542-0, 542-1, . . . may represent data dependencies (e.g., true data dependencies) between compute tasks. A data dependency represented by an edge 542-0, 542-1, . . . may involve a transfer of data (which may be referred to as a global data item) D0, D1 . . . , respectively. A dependency may indicate that a data transfer may be useful or necessary between two compute tasks, devices, and/or the like (e.g., between one or more computational devices, storage devices, data input and/or output devices, memory devices, and/or the like). In some embodiments, the graph 540 may generally illustrated time progressing in a downward direction.

For example, a dependency operation implemented with a compiler may determine that compute tasks CT2 and CT3 may each have a data dependency on compute task CT0 (e.g., CT2 may use output data D0 from CT0 as input data, and CT3 may use output data D1 from CT0 as input) and thus, compute tasks CT2 and CT3 may be located below, and connected to, compute task CT0. However, the compiler may also determine that compute tasks CT2 and CT3 do not have a dependency between them, and thus, CT2 and CT3 may be executed in parallel as indicated by their placement at the same vertical location in FIG. 5.

However, CT2 and CT3 may both initially be scheduled to run on the same computational resource (e.g., the same GPU). Therefore, if CT2 has started executing on the GPU and/or is using a communication connection to the GPU to transfer data D0, it may be beneficial to reschedule compute task CT3 to run on the same computational device on which CT0 is executed (e.g., using an FPGA in a computational storage device). Depending on the implementation details, this may avoid one or more delays caused by transferring data DI and/or waiting for the GPU to complete CT2.

As another example, compute tasks CT0 and CT1 (which may not have a dependency between them) may execute in parallel as indicated by their placement at the same vertical level. Compute task CT3 may have a data dependency 542-1 on CT0 (e.g., to use data D1) as indicated by its placement at a vertical level below CT0. Moreover, compute task CT5 may have data dependencies 542-4 and 542-3 on CT1 and CT3, respectively (e.g., to use data D4 and D3, respectively). Thus, CT5 may be placed at a vertical level below CT3.

In some embodiments, one or more dependencies for the graph 540 may be determined, for example, by searching for one or more functions, instructions, data structures, calls, arguments, parameters, and/or the like, within one or more portions of code and/or compute tasks. In some embodiments, one or more dependencies may be determined, for example, by a compiler interpreter, plug-in or extension for a compiler and/or an interpreter, and/or the like. For example, in some embodiments, a compiler may have existing functionality to determine one or more dependencies, and a plug-in for the compiler may use the one or more dependencies identified by the compiler to assign one or more compute tasks to one or more computational devices.

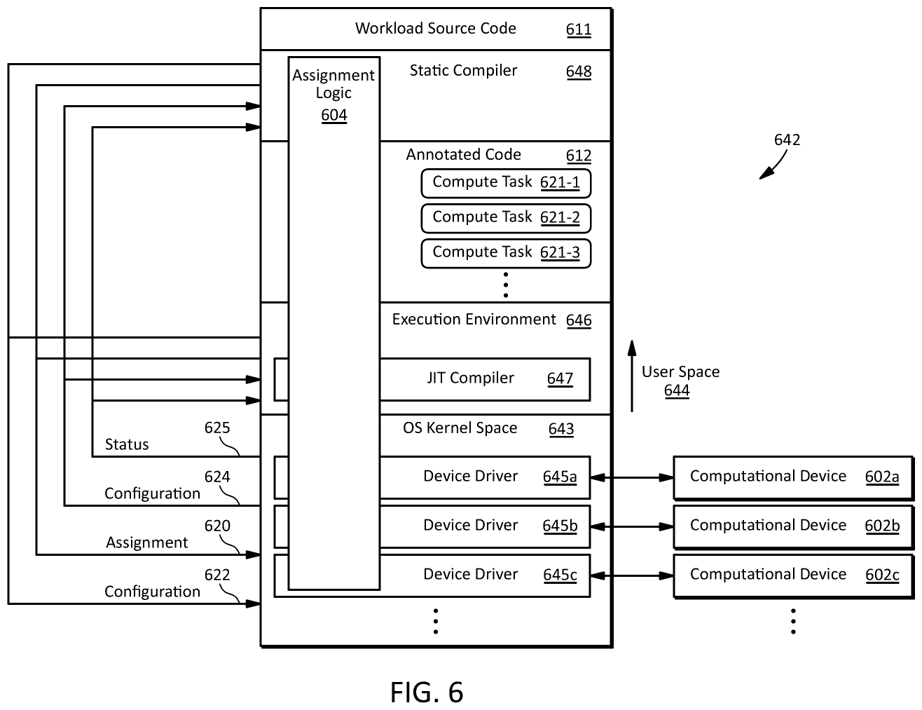

FIG. 6 illustrates an example embodiment of a software architecture in accordance with example embodiments of the disclosure. The embodiment illustrated in FIG. 6 may be used, for example, to implement any of the assignment schemes disclosed herein including those described with respect to other drawings in which similar elements may be indicated by reference numbers ending in, and/or containing, the same digits, letters, and/or the like.

The software architecture 642 illustrated in FIG. 6 may be implemented as, and/or with, a software stack in which a portion may run in an operating system (OS) kernel space 643 and a portion may run in an OS user space 644.

The software architecture 642 may include one or more device drivers 645(a), 645(b), 645(c), . . . that may enable one or more other components of the software stack to communicate with, control, and/or the like, one or more computational devices 602.

Additionally, or alternatively, the software architecture 642 may include a static compiler 648 that may be used, for example, to compile source code 611 for a computational workload. In some embodiments, the static compiler 648 may include at least a portion of assignment logic 604 that may implement one or more operations associated with any of the assignment logic disclosed herein including assignment logic 204 illustrated in FIG. 2 and/or 304a illustrated in FIG. 3, and/or one or more of the operations describe with respect to FIG. 4. For example, static compiler 648 may generate annotated code 612 in which it may identify one or more computational tasks 621-1, 621-2, 621-3, . . . . As another example, the static compiler 648 may perform one or more operations that may be performed by first assignment logic 304a including identifying one or more compute tasks 621, determining one or more characteristics of one or more compute tasks 621, determine, receiving, and/or using configuration information 624 associated with one or more computational devices 602, determining one or more dependencies between one or more compute tasks 621, determining one or more expected performances of one or more compute tasks 621 running on one or more computational devices 602, compiling code to execute one or more compute tasks 621 using one or more computational devices 602, assigning one or more compute tasks 621 to one or more computational devices 602, and/or the like.

Additionally, or alternatively, the software architecture 642 may include an execution environment 646 (e.g., a runtime environment) that may include a JIT compiler 647. In some embodiments, the execution environment 646 may include one or more virtual machines that may implement the JIT compiler 647, run annotated code 612, and/or the like. In some embodiments, the execution environment 646 may include at least a portion of assignment logic 604 that may implement one or more operations associated with any of the assignment logic disclosed herein including assignment logic 204 illustrated in FIG. 2 and/or 304 illustrated in FIG. 3, and/or one or more of the operations described with respect to FIG. 4.

For example, in some embodiments, the execution environment 646 may execute the annotated code 612. As another example, the execution environment 646 may perform one or more operations that may be performed by second assignment logic 304b including any of the operations that may be performed by first assignment logic 304a, but with the advantage of having access to status information 625 that may provide information about one or more operating conditions of one or more computational devices 602 and/or one or more communication connections for the computational devices 602. For example, the execution environment 646 may use status information 625 and/or configuration information 624 to determine one or more expected performances of one or more compute tasks 621 running on one or more computational devices 602, compile or recompile code to execute one or more compute tasks 621 using one or more computational devices 602, assign, reassign, schedule, reschedule, and/or the like, one or more compute tasks 621 to one or more computational devices 602, and/or the like.

In some embodiments, one or more of the components illustrated in FIG. 6 may implement one or more application programming interfaces (APIs). For example, in some embodiments, one or more of the static compiler 648 and/or execution environment 646 may implement an API that may enable a computational workload (e.g., an application), a software developer, and/or the like, to access one or more of the features of the assignment logic 604, one or more resources of a computational device, and/or the like.

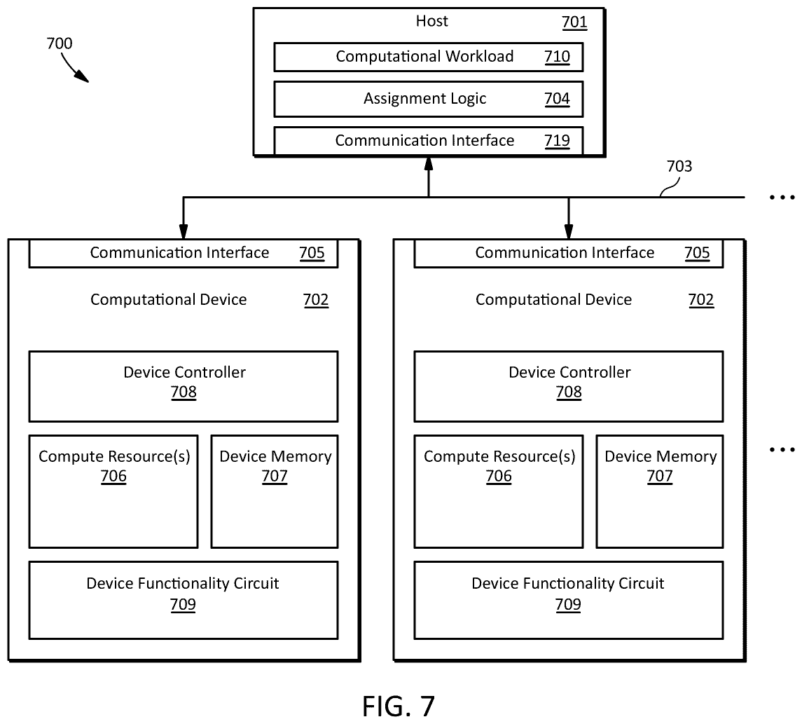

FIG. 7 illustrates an embodiment of a computing system in accordance with example embodiments of the disclosure. The computing system 700 illustrated in FIG. 7 may be used to implement any of the assignment schemes disclosed herein, including those described with respect to other drawings in which similar elements may be indicated by reference numbers ending in, and/or containing, the same digits, letters, and/or the like.

The computing system 700 illustrated in FIG. 7 may include a host 701 and one or more computational devices 702. In some embodiments, the host 701 may be implemented with more than one host which may be referred to individually and/or collectively as host 701. Host 701 and one or more computational devices 702 may be configured to communicate using one or more communication connections 703.

The computing system 700 may include assignment logic 704 that may include functionality to assign a computational workload 710, or one or more portions of the computational workload 710 (which may include and/or be referred to as one or more compute tasks), to one or more computational devices 702. In some embodiments, the assignment logic 704 may be located at least partially at host 701 as illustrated in FIG. 7. In some embodiments, some or all of the assignment logic 704 may be located at multiple hosts, at one or more computational devices 702, at a user of the computing system 700, and/or at any other location.

A host 701 may be implemented with any component or combination of components that may utilize one or more features of a computational device 702. For example, a host may be implemented with one or more of a server, a storage node, a compute node, a central processing unit (CPU), a workstation, a personal computer, a tablet computer, a smartphone, and/or the like, or multiples and/or combinations thereof.

A computational device 702 may include a communication interface 705, memory 707 (some or all of which may be referred to as device memory), one or more compute resources 706 (which may also be referred to as computational resources), a device controller 708, and/or a device functionality circuit 709. The device controller 708 may control the overall operation of the computational device 702 including any of the operations, features, and/or the like, described herein. For example, in some embodiments, the device controller 708 may execute one or more computational tasks received from the host 701 using one or more compute resources 706.

The device functionality circuit 709 may include any hardware to implement a primary function of the computational device 702. For example, if the computational device 702 is implemented as a storage device (e.g., a computational storage device), the device functionality circuit 709 may include storage media such as magnetic media (e.g., if the computational device 702 is implemented as a hard disk drive (HDD) or a tape drive), solid state media (e.g., one or more flash memory devices), optical media, and/or the like. For instance, in some embodiments, a storage device may be implemented at least partially as a solid state drive (SSD) based on not-AND (NAND) flash memory, persistent memory (PMEM) such as cross-gridded nonvolatile memory, memory with bulk resistance change, phase change memory (PCM), or any combination thereof. In an embodiment in which the computational device 702 is implemented as a storage device, the device controller 708 may include a media translation layer such as a flash translation layer (FTL) for interfacing with one or more flash memory devices. In some embodiments, a computational storage device may be implemented as a computational storage drive, a computational storage processor (CSP), and/or a computational storage array (CSA).

As another example, if the computational device 702 is implemented as a network interface controller (NIC) (e.g., a network interface card), the device functionality circuit 709 may include one or more modems, network interfaces, physical layers (PHYs), medium access control layers (MACs), and/or the like. As a further example, if the computational device 702 is implemented as an accelerator, the device functionality circuit 709 may include one or more accelerator circuits, memory circuits, and/or the like.

The one or more compute resources 706 may be implemented with any component or combination of components that may perform operations on data that may be received, stored, and/or generated at the computational device 702. Examples of compute resources may include combinational logic, sequential logic, timers, counters, registers, state machines, CPLDs, FPGAs, application specific integrated circuits (ASICs), embedded processors, microcontrollers, CPUs such as complex instruction set computer (CISC) processors (e.g., x86 processors) and/or a reduced instruction set computer (RISC) processors such as ARM processors, graphics processing units (GPUs), data processing units (DPUs), neural processing units (NPUs), tensor processing units (TPUs), and/or the like, that may execute instructions stored in any type of memory and/or implement any type of execution environment such as a container, a virtual machine, an operating system such as Linux, an Extended Berkeley Packet Filter (eBPF) environment, and/or the like, or a combination thereof.

The memory 707 may be used, for example, by one or more of the compute resources 706 to store input data, output data (e.g., computation results), intermediate data, transitional data, and/or the like. The memory 707 may be implemented, for example, with volatile memory such as dynamic random access memory (DRAM), static random access memory (SRAM), and/or the like, as well as any other type of memory such as nonvolatile memory.

In some embodiments, the memory 707 and/or compute resources 706 may include software, instructions, programs, code, and/or the like, that may be performed, executed, and/or the like, using one or more compute resources (e.g., hardware (HW) resources). Examples may include software implemented in any language such as assembly language, C, C++, and/or the like, binary code, FPGA code, one or more operating systems, kernels, environments such as eBPF, and/or the like. Software, instructions, programs, code, and/or the like, may be stored, for example, in memory 707 and/or compute resources 706. Software, instructions, programs, code, and/or the like, may be downloaded, uploaded, sideloaded, pre-installed, built-in, and/or the like, to the memory 707 and/or compute resources 706. In some embodiments, the computational device 702 may receive one or more instructions, commands, and/or the like, to select, enable, activate, execute, and/or the like, software, instructions, programs, code, and/or the like. Examples of computational operations, functions, and/or the like, that may be implemented by the memory 707, compute resources 706, software, instructions, programs, code, and/or the like, may include any type of algorithm, data movement, data management, data selection, filtering, encryption and/or decryption, compression and/or decompression, checksum calculation, hash value calculation, cyclic redundancy check (CRC), weight calculations, activation function calculations, training, inference, classification, regression, and/or the like, for artificial intelligence (AI), machine learning (ML), neural networks, and/or the like.

A communication interface 719 at a host 701, a communication interface 705 at a device 702, and/or a communication connection 703 may implement, and/or be implemented with, one or more data buses, one or more interconnects, one or more networks, a network of networks (e.g., the internet), and/or the like, or a combination thereof, using any type of interface, protocol, and/or the like. For example, the communication connection 703, and/or one or more of the interfaces 705 and/or 719 may implement, and/or be implemented with, any type of wired and/or wireless communication medium, interface, network, interconnect, protocol, and/or the like including Peripheral Component Interconnect Express (PCIe), Nonvolatile Memory Express (NVMe), NVMe over Fabric (NVMe-oF), Compute Express Link (CXL), and/or a coherent protocol such as CXL.mem, CXL.cache, CXL.io and/or the like, Gen-Z, Open Coherent Accelerator Processor Interface (OpenCAPI), Cache Coherent Interconnect for Accelerators (CCIX), and/or the like, Advanced extensible Interface (AXI), Direct Memory Access (DMA), Remote DMA (RDMA), RDMA over Converged Ethernet (ROCE), Advanced Message Queuing Protocol (AMQP), Ethernet, Transmission Control Protocol/Internet Protocol (TCP/IP), FibreChannel, InfiniBand, Serial ATA (SATA), Small Computer Systems Interface (SCSI), Serial Attached SCSI (SAS), iWARP, any generation of wireless network including 2G, 3G, 4G, 5G, 6G, and/or the like, any generation of Wi-Fi, Bluetooth, near-field communication (NFC), and/or the like, or any combination thereof. In some embodiments, a communication connection 703 may include one or more switches, hubs, nodes, routers, and/or the like.

A computational device 702 may be implemented in any physical form factor. Examples of form factors may include a 3.5 inch, 2.5 inch, 1.8 inch, and/or the like, storage device (e.g., storage drive) form factor, M.2 device form factor, Enterprise and Data Center Standard Form Factor (EDSFF) (which may include, for example, E1.S, E1.L, E3.S, E3.L, E3.S 2T, E3.L 2T, and/or the like), add-in card (AIC) (e.g., a PCIe card (e.g., PCIe expansion card) form factor including half-height (HH), half-length (HL), half-height, half-length (HHHL), and/or the like), Next-generation Small Form Factor (NGSFF), NF1 form factor, compact flash (CF) form factor, secure digital (SD) card form factor, Personal Computer Memory Card International Association (PCMCIA) device form factor, and/or the like, or a combination thereof. Any of the computational devices disclosed herein may be connected to a system using one or more connectors such as SATA connectors, SCSI connectors, SAS connectors, M.2 connectors, EDSFF connectors (e.g., connectors compatible with SFF-TA-1002 and/or SFF-TA-1009 such as 1C, 2C, 4C, 4C+, and/or the like), U.2 connectors (which may also be referred to as SSD form factor (SFF) SFF-8639 connectors), U.3 connectors, PCIe connectors (e.g., card edge connectors), and/or the like.

Any of the computational devices disclosed herein may be used in connection with one or more personal computers, smart phones, tablet computers, servers, server chassis, server racks, datarooms, datacenters, edge datacenters, mobile edge datacenters, and/or any combinations thereof.

In some embodiments, a computational device 702 may be implemented with any device that may include, or have access to, memory, storage media, and/or the like, to store data that may be processed by one or more compute resources 706. Examples may include memory expansion and/or buffer devices such as CXL type 2 and/or CXL type 3 devices, as well as CXL type 1 devices that may include memory, storage media, and/or the like.

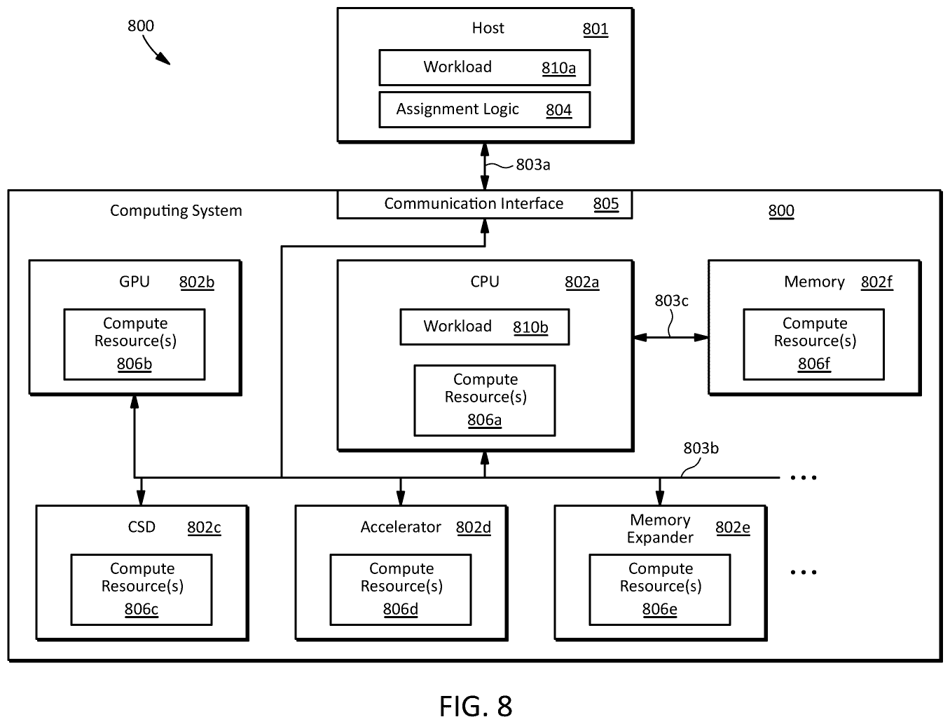

FIG. 8 illustrates an example embodiment of a computing system in accordance with example embodiments of the disclosure. The computing system 800 illustrated in FIG. 8 may be used to implement any of the assignment schemes disclosed herein, including those described with respect to other drawings in which similar elements may be indicated by reference numbers ending in, and/or containing, the same digits, letters, and/or the like.

For purposes of illustration, the computing system 800 illustrated in FIG. 8 may be described in the context of a system in which computational devices may communicate using an interconnect physical (PHY) layer such as a PCIe physical layer with one or more protocols such as a PCIe protocol, CXL.cache, CXL.mem, CXL.io, and/or the like. However, aspects of the disclosure may be implemented with computational devices using any other communication scheme such as computational devices that may communicate using network infrastructure (e.g., a network fabric) based, for example, on an Ethernet protocol.

The computing system 800 may include one or more CPUs 802a, one or more GPUs 802b, one or more computational storage devices 802c, one or more accelerators 802d, one or more memory expanders 802e, one or more memory devices 802f, and/or the like, which may be referred to individually and/or collectively as 802. The one or more CPUs 802a, GPUs 802b, computational storage devices 802c, accelerators 802d, memory expanders 802e, and/or memory devices 802f may include compute resources 806a, 806b, 806c, 806d, 806e, and/or 806f, respectively, which may be referred to individually and/or collectively as 806.

FIG. 8 also illustrates a host 801 which may be separate from and/or integrated with, the computing system 800. For example, in some embodiments, a host 801 may be implemented as a separate component that may run a workload 810a that may offload one or more compute tasks to one or more computational devices 802 in the computing system 800. In some other embodiments, a CPU 802a may function as a host that may run a workload 810b that may offload one or more compute tasks to one or more other computational devices 802. In such an embodiment, a CPU 802a (either the CPU that runs the workload 810b or a different CPU) may also function as a computational device. In yet other embodiments, a workload 810 may run partially on a separate host 801 and partially on one or more CPUs 802a and offload one or more compute tasks to one or more other computational devices 802.

In some embodiments, the computing system 800 may include assignment logic 804 that may implement any or all of the task assignment schemes disclosed herein, or one or more portions thereof. In some embodiments, the assignment logic 804 may be located at least partially at host 801 as illustrated in FIG. 8. In some embodiments, some or all of the assignment logic 804 may be located at multiple hosts, at one or more computational devices 802, at a user of the computing system 800, and/or at any other location.

The computational devices 802 may communicate using one or more communication connections 803a which, as mentioned above, in some embodiments, may be implemented using a PCIe physical layer with one or more protocols such as a PCIe protocol, CXL.cache, CXL.mem. CXL.io, and/or the like. In such an embodiment, any of the computational devices 802 may be implemented with one or more mechanical configurations compatible with a PCIe physical layer including form factors such as adapter card form factors (e.g., PCIe adapter cards), storage device form factors (e.g., 3.5 inch, 2.5 inch, M.2, and/or EDSFF form factors such as E1.S, E1.L, E3.S, and/or E3.L), and/or the like. Also in such an embodiment, any of the computational devices 802 may be implemented with one or more connectors configurations compatible with a PCIe physical layer such as card edge connectors (e.g., PCIe card edge connectors), U.2 connectors, U.3 connectors, EDSFF connectors (e.g., connectors compatible with SFF-TA-1002 and/or SFF-TA-1009), M.2 connectors, and/or the like.

In embodiments that use an interconnect physical layer such as a PCIe PHY layer, one or more of the communication connections 803 may be implemented with one or more PCIe fabrics that may include one or more root complexes, switches, retimers, and/or the like. For example, one or more communication connections 803b may be implemented with one or more root complexes at a CPU 802a and/or one or more switches that may enable a CPU 802a to communicate with any of the other computational devices 802, as well as a communication interface 805 (e.g., a network interface card or controller, an interconnect card or controller, and/or the like) that may enable the computational system 800 to communicate with a host 801. In embodiments in which a host 801 may be at least partially separate from the computational system 800, one or more communication connections 803a may be implemented with an interconnect such as PCIe, a network such as Ethernet, and/or the like.

In some embodiments, a computational device 802f may be implemented with a memory module form factor such as a dual inline memory module (DIMM) that may implement one or more communication connections 803c with a memory interface such as a double data rate (DDR) memory interface. In such an embodiment, one or more compute resources 806f at a computational device 802f may be implemented, for example, with processing-in-memory (PIM) functionality that may include computing resources on one or more memory dies, on one or more logic dies connected to (e.g., stacked with) one or more memory dies, and/or the like. In some embodiments, a computational device 802f may be implemented with PIM using a high bandwidth memory (HBM) interface.

Although the computational system 800 is not limited to any specific physical configuration, in some embodiments, the computational system 800 may be implemented with a server such as a compute server, a storage server, and/or the like, configured as one or more chassis, blades, racks, clusters, datacenters, edge datacenters, and/or the like.

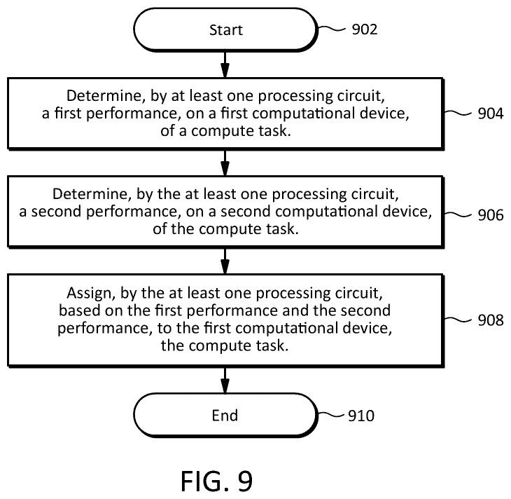

FIG. 9 illustrates another embodiment of a method for assigning compute tasks to one or more computational devices in accordance with example embodiments of the disclosure. The method may begin at operation 902. At operation 904, the method may determine, by at least one processing circuit, a first performance, on a first computational device, of a compute task. For example, referring to FIG. 3 and/or FIG. 4, a performance determination operation 434 may determine (e.g., predict) an estimated performance of a compute task 321-1 on a first computational device such as a first one of CPU 302a, GPU 302b, computational storage device 302c, and/or the like.

At operation 906, the method may determine, by the at least one processing circuit, a second performance, on a second computational device, of the compute task. For example, referring again to FIG. 3 and/or FIG. 4, a performance determination operation 434 may determine (e.g., predict) an estimated performance of the compute task 321-1 on a second computational device such as a second one of CPU 302a, GPU 302b, computational storage device 302c, and/or the like.

At operation 908, the method may assign, by the at least one processing circuit, based on the first performance and the second performance, to the first computational device, the compute task. For example, referring again to FIG. 3 and/or FIG. 4, a decision operation 437 may decide to assign and/or schedule the compute task 321-1 to the first one of the CPU 302a, GPU 302b, computational storage device 302c, and/or the like. The method may end at operation 910.

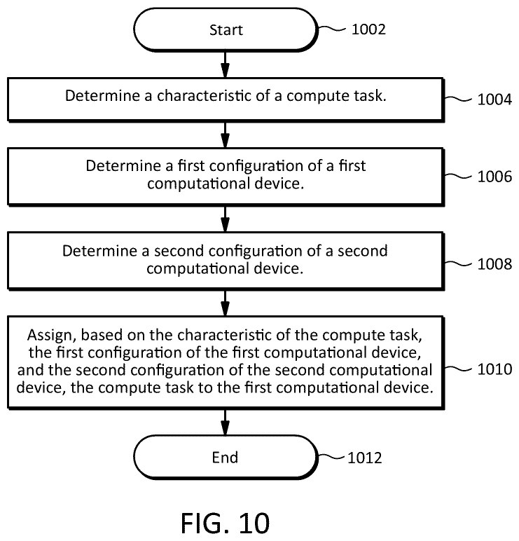

FIG. 10 illustrates a further embodiment of a method for assigning compute tasks to one or more computational devices in accordance with example embodiments of the disclosure. The method may begin at operation 1002. At operation 1004, the method may determine a characteristic of a compute task. For example, referring to FIG. 3 and/or FIG. 4, a profiling operation 431 may determine a characteristic of a compute task 321-1.

At operation 1006, the method may determine a first configuration of a first computational device. For example, referring to FIG. 3, first assignment logic 304a may determine a configuration of a first computational device such as a first one of CPU 302a, GPU 302b, computational storage device 302c, and/or the like, based, for example, on receiving configuration information 324.

At operation 1008, the method may determine a second configuration of a second computational device. For example, referring to FIG. 3, first assignment logic 304a may determine a configuration of a second computational device such as a second one of CPU 302a, GPU 302b, computational storage device 302c, and/or the like, based, for example, on receiving configuration information 324.

At operation 1010, the method may assign, based on the characteristic of the compute task, the first configuration of the first computational device, and the second configuration of the second computational device, the compute task to the first computational device. For example, referring to FIG. 3 and/or FIG. 4, a decision operation 437 may assign and/or schedule the compute task 321-1 to the first one of the CPU 302a, GPU 302b, computational storage device 302c, and/or the like, as shown by assignment information 320. The method may end at operation 1012.

The embodiments illustrated in FIG. 9 and FIG. 10, as well as all of the other embodiments described herein, are example operations and/or components. In some embodiments, some operations and/or components may be omitted and/or other operations and/or components may be included. Moreover, in some embodiments, the temporal and/or spatial order of the operations and/or components may be varied. Although some components and/or operations may be illustrated as individual components, in some embodiments, some components and/or operations shown separately may be integrated into single components and/or operations, and/or some components and/or operations shown as single components and/or operations may be implemented with multiple components and/or operations.

Any of the functionality described herein, including any of the host functionality, device functionally, and/or the like, as well as any of the functionality described with respect to the embodiments illustrated in FIGS. 1-11 may be implemented with hardware, software, firmware, or any combination thereof including, for example, hardware and/or software combinational logic, sequential logic, timers, counters, registers, state machines, volatile memories such DRAM and/or SRAM, nonvolatile memory including flash memory, persistent memory such as cross-gridded nonvolatile memory, memory with bulk resistance change, PCM, and/or the like and/or any combination thereof, complex programmable logic devices (CPLDs), FPGAs, ASICs, CPUs including CISC processors such as x86 processors and/or RISC processors such as ARM processors, GPUs, NPUs, TPUs, and/or the like, executing instructions stored in any type of memory. In some embodiments, one or more components may be implemented as a system-on-chip (SOC), a multi-chip module, one or more chiplets (e.g., integrated circuit (IC) dies) in a package, and/or the like.

Some embodiments may break down performance characteristics for separate code portions and/or model data transfer overhead. Some embodiments may automatically capture workload characteristics, for example, to decide suitability for computational storage device offloading. Some embodiments may determine (e.g., predict) an acceptable or optimal computational storage device acceleration performance which, depending on the implementation details, may be determined before implementing one or more compute resources (e.g., an FPGA) for the computational storage device. Some embodiments may provide insights on how to utilize (e.g., fully utilize) one or more available computing resources to improve (e.g., maximize) performance of a heterogeneous system (e.g., a system with a processing unit such as CPU or GPU with a computational storage device. Some embodiments may allow design space exploration for hardware, for example, by tuning one or more hardware configurations. In some embodiments, a data-driven model may enable a better understanding of memory and/or storage design choices, for example, for data-intensive applications. Some embodiments may help provide insights into computational storage technologies such as those implemented with a CXL interface, protocol, and/or the like. Some embodiments may focus on data sharing and/or movement patterns, and thus may provide insights into one or more effects of cache sharing on hiding a data transfer latency with the help of computational storage technologies such as those utilizing CXL.

Some embodiments disclosed above have been described in the context of various implementation details, but the principles of this disclosure are not limited to these or any other specific details. For example, some functionality has been described as being implemented by certain components, but in other embodiments, the functionality may be distributed between different systems and components in different locations and having various user interfaces. Certain embodiments have been described as having specific processes, operations, etc., but these terms also encompass embodiments in which a specific process, operation, etc. may be implemented with multiple processes, operations, etc., or in which multiple processes, operations, etc. may be integrated into a single process, step, etc. A reference to a component or element may refer to only a portion of the component or element. For example, a reference to a block may refer to the entire block or one or more subblocks. The use of terms such as “first” and “second” in this disclosure and the claims may only be for purposes of distinguishing the elements they modify and may not indicate any spatial or temporal order unless apparent otherwise from context. In some embodiments, a reference to an element may refer to at least a portion of the element, for example, “based on” may refer to “based at least in part on,” and/or the like. A reference to a first element may not imply the existence of a second element. The principles disclosed herein have independent utility and may be embodied individually, and not every embodiment may utilize every principle. However, the principles may also be embodied in various combinations, some of which may amplify the benefits of the individual principles in a synergistic manner. The various details and embodiments described above may be combined to produce additional embodiments according to the inventive principles of this patent disclosure.

Since the inventive principles of this patent disclosure may be modified in arrangement and detail without departing from the inventive concepts, such changes and modifications are considered to fall within the scope of the following claims.

1. A method comprising:
determining, by at least one processing circuit, a first performance, on a first computational device, of a compute task;
determining, by the at least one processing circuit, a second performance, on a second computational device, of the compute task; and
assigning, by the at least one processing circuit, based on the first performance and the second performance, to the first computational device, the compute task.

2. The method of claim 1, wherein:
the compute task comprises at least one instruction; and
the determining the first performance is based on the at least one instruction.

3. The method of claim 1, wherein the determining the first performance is based on a data transfer associated with the compute task.

4. The method of claim 1, wherein:
the compute task is a first portion of a computational workload; and
the assigning is based on a dependency associated with the first portion of the computational workload on a second portion of the computational workload.

5. The method of claim 1, wherein:
the first computational device comprises a compute resource; and
the determining the first performance is based on a type of the compute resource.

6. The method of claim 1, wherein the first computational device comprises a configurable compute resource, the method further comprising configuring, based on the assigning, the configurable compute resource.

7. The method of claim 6, wherein the configuring comprises loading, at the first computational device, a program for the configurable compute resource.

8. The method of claim 1, wherein the determining the first performance is based on:
a characteristic of the compute task; and
a configuration of the first computational device.

9. The method of claim 1, wherein the determining the first performance is based on an operating status of the first computational device.

10. The method of claim 1, wherein the determining the first performance is based on an operating status of the second computational device.

11. The method of claim 1, wherein the determining the first performance is based on an operating status of a communication connection for the first computational device.

12. The method of claim 1, wherein the determining the first performance is based on an operating status of a communication connection for the second computational device.

13. The method of claim 1, wherein the compute task comprises at least one instruction, the method further comprising compiling, based on the assigning, the at least one instruction for the first computational device.

14. The method of claim 1, wherein the compute task is a first portion of a computational workload, the method further comprising determining, based on the computational workload, the compute task.

15. A method comprising:
determining a characteristic of a compute task;
determining a first configuration of a first computational device;
determining a second configuration of a second computational device; and
assigning, based on the characteristic of the compute task, the first configuration of the first computational device, and the second configuration of the second computational device, the compute task to the first computational device.

16. The method of claim 15, wherein the assigning is based on an operating status of the first computational device.

17. The method of claim 15, wherein the assigning is based on a data transfer associated with the compute task.

18. A system comprising:
a first computational device;
a second computational device; and
assignment logic configured to assign, based on a characteristic of a compute task, a first configuration of the first computational device, and a second configuration of the second computational device, the compute task to the first computational device.

19. The system of claim 18, wherein the assignment logic is further configured to assign the compute task based on an operating status of the first computational device.

20. The system of claim 18, wherein the assignment logic is further configured to assign the compute task based on a data transfer associated with the first computational device.
